(19) United States
(12) Patent Application Publication
(10) Pub. No.: US 2012/0328955 A1
(43) Pub. Date: Dec. 27, 2012

(54) LITHIUM SECONDARY BATTERY HAVING HIGH CAPACITY

(75) Inventors: Kyoung Han Ryu, Uiwang (KR); Dong Hui Kim, Seoul (KR); Ho Taek Lee, Seoul (KR); Sunggoo Yun, Yongin (KR)

(73) Assignee: HYUNDAI MOTOR COMPANY, Seoul (KR)

(21) Appl. No.: 13/271,564

(22) Filed: Oct. 12, 2011

(30) Foreign Application Priority Data
Jun. 27, 2011 (KR) 10-2011-0062511

(51) Int. Cl. H01M 4/48; H01M 4/36

(52) U.S. Cl. 429/231.95; 429/218.1

(57) ABSTRACT

A lithium battery is formed with a combination of an increased capacity negative electrode material capable of replacing a lithium metal electrode and a high capacity positive electrode material capable of realizing a high energy density. Particularly, the lithium secondary battery includes a negative electrode, and a positive electrode containing lithium oxide (Li₂O) or lithium peroxide (Li₂O₂) as an active material.

### CROSS-REFERENCE TO RELATED APPLICATION

This application claims under 35 U.S.C. §119(a) the benefit of Korean Patent Application No. 10-2011-0062511 filed Jun. 27, 2011, the entire contents of which are incorporated herein by reference.

### BACKGROUND

(a) Technical Field

The present invention relates to a lithium secondary battery having high capacity. More particularly, it relates to a lithium secondary battery formed in combination with a negative electrode material having high capacity which is capable of replacing a lithium metal electrode and a positive electrode material having high capacity which is capable of realizing a high energy density therein.

(b) Background Art

Recently, as environmental protection and air pollution become serious problems, studies for developing alternative energy sources have actively been made all over the world. Conventional battery systems, which belong to one field of the studies for developing the alternative energy, may be classified into a lithium metal battery and a lithium ion battery.

In the case of a currently commercialized lithium ion battery of the conventional battery systems, graphite having a theoretical capacity of approximately 370 mAh/g per weight (g) is mainly applied to a negative electrode of the battery. Silicon has recently been studied as a new material for the next generation negative electrode. By using silicon as the negative electrode, a high capacity of more than 4000 mAh/g can be realized. Additionally, when using lithium metal as a negative electrode material, a high capacity of more than 3800 mAh/g can be realized (which is more than 10 times that of graphite).

Often lithium metal oxide (LMO) has been used as a positive electrode more frequently than a negative electrode of such lithium ion battery, the LMO only has a theoretical capacity of approximately 150 to 200 mAh per weight (g), thereby limiting the realization of high energy density when the lithium metal oxide is used together with a negative electrode having a high capacity in a secondary battery.

An illustrative reaction of a lithium ion battery according to a conventional art may be indicated by the following reaction formula 1.

LiCoO₂+6C [symbol] CoO₂+LiC₆ (158 mAh/g_{—active material}) (Reaction formula 1)

The lithium ion battery according to a conventional art is not appropriate for use as a battery for long distance electric vehicles because of the limited theoretical energy density. To solve this problem and realize a high enough energy density in the electrodes, it is necessary to apply positive electrode and negative electrode materials having high energy densities to the electrodes.

Materials capable of realizing a large capacity of more than that of the lithium metal oxide may include air (oxygen) and sulfur positive electrodes, etc. Studies of lithium metal batteries (lithium air battery, lithium sulfur battery, etc.) having a large energy density of approximately 10 times the theoretical energy density of the existing lithium ion battery have conducted.

A typical lithium air battery system including a conventional lithium air (lithium metal) battery as shown in FIG. 1 utilizes a lithium metal having a large energy density as a negative electrode and air (oxygen) capable of being supplied infinitely from the atmosphere as an active material for positive electrode. In particular, when a reaction within the battery generates electricity, a discharge reaction is first performed, during which lithium ions are discharged from the negative electrode made of lithium metal to thereby be stored into a porous positive electrode, and then, the lithium ions stored in the positive electrode react with outside air.

However, when lithium metal is used as a negative electrode in a lithium air battery above and the battery is charged and discharged, a surface of the negative electrode is changed to an acicular structure (dendrite), called dendrite lithium, as shown in FIG. 2, due to the uneven adsorption and desorption of the lithium ions. When such dendrite lithium is excessive, the dendrite lithium pierces through an inner separator membrane of the battery thereby introducing physical contact between the positive electrode and negative electrode, thereby generating short within the battery. As a result, the battery may become dangerous and may cause an explosion.

Also, when the reactivity of lithium ions decreases due to repeated charging and discharging processes, a certain amount of lithium must be added in place of the no longer active lithium. Thus, the real energy density becomes reduced.

An illustrative reaction in a conventional lithium air battery may be indicated by the following reaction formula 2.

2Li+O₂ [symbol] Li₂O₂ (1165 mAh/g_{—active material})

4Li+O₂ [symbol] 2Li₂O (1787 mAh/g_{—active material}) (Reaction formula 2)

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a lithium secondary battery having increased capacity that is formed with a negative electrode of high capacity employing a tin based material or a silicon based material instead of lithium metal and a positive electrode of high capacity employing lithium oxide (Li₂O) or lithium peroxide (Li₂O₂), thereby realizing a lithium secondary battery having increased capacity.

In one aspect, the present invention provides a lithium secondary battery having increased capacity that is formed with a negative electrode and a positive electrode including lithium oxide (Li₂O) or lithium peroxide (Li₂O₂) as active materials.

In an exemplary embodiment, the negative electrode includes as an active material, any one selected from the group consisting of silicon based material, tin based material and lithium metal.

In another preferred embodiment, it is preferable that the positive electrode is formed of porous material.

The lithium secondary battery according to the present invention includes a negative electrode having increased capacity and a positive electrode having increased capacity thereby realizing a high energy density and preventing dendrite lithium from being generated on a surface of the negative electrode, resulting in an enhancement in safety. Accordingly, the lithium secondary battery according to the present invention may be applied to long distance electric vehicles for next generation.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic view showing the structure of lithium metal battery (lithium air battery) according to a conventional art;

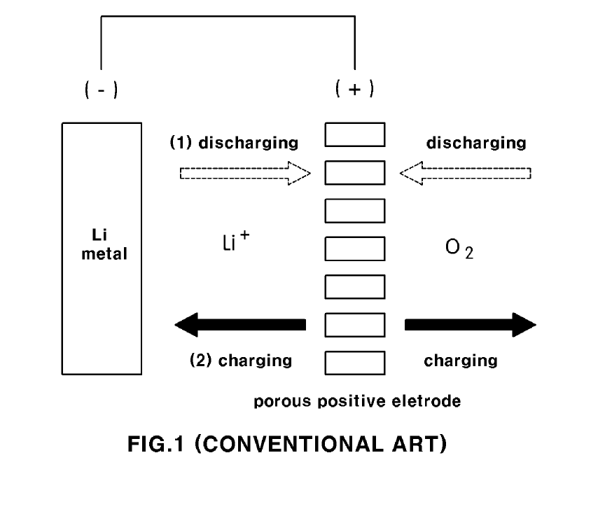

FIG. 2 is a view illustrating the principle of lithium growth of acicular structure in the lithium metal battery according to a conventional art;

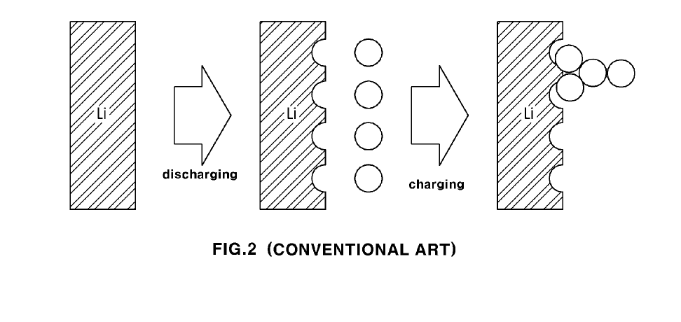

FIG. 3 is a schematic view showing a lithium secondary battery having a high capacity according to an exemplary embodiment of present invention; and

FIG. 4 is a graph showing a coin cell electrochemical estimation result of the lithium air battery system according to an example 1 of the present invention and a comparative example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The non-aqueous lithium secondary battery having a high capacity according to the present invention includes a positive electrode and a negative electrode including a material of high energy density as an active material to realize a high energy density. The active material of the negative electrode includes a tin based material or a silicon based material having a high energy density instead of a lithium metal. Unlike the conventional batteries, however, where silicon material is used as negative electrode and a conventional positive electrode uses a lithium cobalt oxide or other lithium metal oxide similar to it, the present invention uses a lithium oxide e.g., lithium oxide or lithium peroxide without a transition metal as a positive electrode.

Since the lithium metal also has a high energy density, it may be possible to use the lithium metal as an active material of negative electrode. However, to prevent a dendritic pattern of lithium from being generated due to the repeated charging and discharging, the present invention employs a silicon based material or a tin based material as the active material in negative electrode.

More specifically, to realize a negative electrode having increased capacity, it is preferable that the active material of negative electrode is used with any one selected from the group of silicon, silicon oxide and silicon alloy, or with any one selected from the group of tin, tin oxide and tin alloy. As described above, the silicon can realize a capacity of more than approximately 4000 mAh/g.

Also, the positive electrode employs as an active material lithium peroxide or lithium oxide containing lithium having increased energy density, thereby eliminating the problems associated with the conventional lithium battery.

Particularly, the present invention employs lithium oxide (Li₂O) or lithium peroxide (Li₂O₂) having a higher theoretical energy density than an existing lithium metal such as lithium cobalt oxide (LiCoO₂). Such positive electrode is formed by employing a porous material so that oxygen (air) contained in atmosphere and lithium ions contained in a battery solution (electrolyte) may be reacted with each other. For example, the positive electrode may be formed in the same structure as an air electrode of a conventional lithium air battery. That is, the positive electrode is formed with a porous positive electrode containing lithium oxide (Li₂O) or lithium peroxide (Li₂O₂).

In this manner, the non-aqueous lithium secondary battery according to the present invention is formed with a positive electrode of increased capacity containing lithium oxide (Li₂O) or lithium peroxide (Li₂O₂) as the active material of the positive electrode and a negative electrode of increased capacity containing a silicon based material or a tin based material as an active material of negative electrode, and has the same structure as a general lithium air battery.

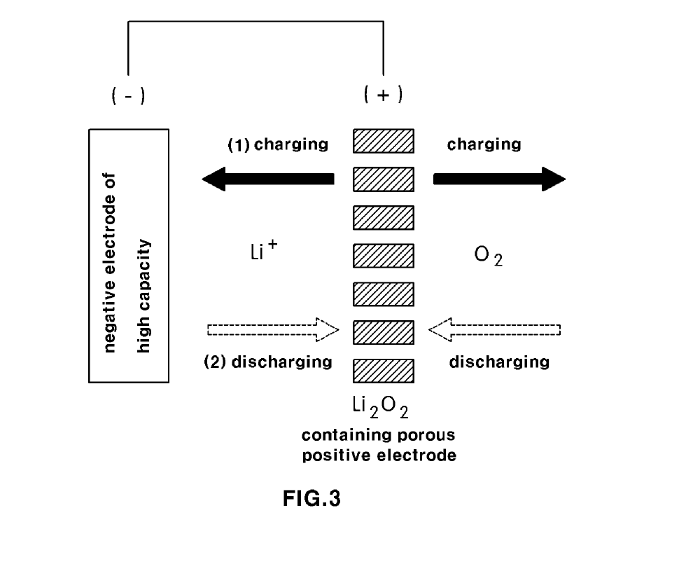

As shown in FIG. 3, the lithium secondary battery according to the present invention first performs a charge reaction (oxygen generating reaction, OER), during which lithium ions are supplied from a porous positive electrode containing lithium oxide (Li₂O) or lithium peroxide (Li₂O₂) to a negative electrode side thereby charging the negative electrode, when charge and discharge reactions are generated between the positive electrode and negative electrode. During the charge reaction, oxygen is discharged into atmosphere. Then, the positive electrode is supplied with lithium ions discharged from the negative electrode thereby being charged and supplied with oxygen contained in atmosphere and generating a discharge reaction. By repeating the charge and discharge reactions, electricity is generated.

A reaction of the lithium secondary battery according to the present invention may be indicated by the following reaction formula 3.

2.2Li₂O₂+Si [symbol] Li_{4.4}Si+2.2O₂ (913 mAh/g_{—active material})

2.2Li₂O+Si [symbol] Li_{4.4}Si+1.1O₂ (945 mAh/g_{—active material}) (Reaction formula 3)

The non-aqueous lithium secondary battery according to the present invention is formed as a combination of a negative electrode material capable of replacing the existing lithium metal electrode and a positive electrode material capable of realizing increased energy density, thereby realizing a battery system having increased energy density as well as preventing dendritic lithium from being generated to thereby enhance the safety of a battery. By doing so, the lithium secondary battery according to the present invention may be applied to a battery for a next generation long distance electric vehicle.

A conventional lithium secondary battery reactivity needs to be controlled by appropriately adjusting the utilization rate of lithium ions and considering the safety of the structure of an electrode's active material. Accordingly, the energy density decreases thereby obtaining a real capacity that is less than the theoretical capacity.

For example, in the case of a conventional lithium ion battery performing a reaction according to the reaction formula 1, only 50% of the lithium ions are used (Li_{0.5} CoO₂) by controlling the reactivity, and thus the discharge capacity is reduced from 158 mAh/g to 100 mAh/g by weight of the positive electrode and negative electrode active material.

In the case of a conventional lithium air battery performing a reaction according to the reaction formula 2, the discharge capacity is reduced from 1165 mAh/g or 1787 mAh/g to 29 lmAh/g by weight of the positive electrode and negative electrode active material by controlling reactivity and the excessively utilized lithium (which means that a certain amount of lithium remains in a negative electrode and lithium other than the remaining lithium is used to maintain the structure of a negative electrode during charging and discharging).

In the case of the lithium secondary battery of the present invention a reaction is performed according to the reaction formula 3, the discharge capacity is reduced from 913 mAh/g or 945 mAh/g to 26 lmAh/g by weight of the positive electrode and negative electrode active material. In such a manner, the lithium secondary battery of the present invention can secure the energy of approximately 90% compared with the conventional lithium air battery by controlling of the reactivity, and thus, securing the safety of the structure of an electrode active material.

Particularly, since the lithium secondary battery according to the present invention performs first a charge reaction when producing electric energy, the battery is relatively low in the reduction amount of the capacity while controlling the reactivity. Accordingly, the lithium secondary battery of the present invention can realize an energy density that is at substantially the same level as a conventional lithium air battery having a high energy density. However, the lithium secondary battery of the present invention can also maintain structural safety which is superior to the negative electrode' which use lithium metal hereby enhancing the expected life span of a battery.

Hereinafter, the following examples illustrate the invention but are not intended to limit the same.

### Example 1

Silicon powder, graphite and acetylene black are mixed at a mixing ratio of 60:35:5 by weight, and then, are mixed with a solution in which polyvinylidene fluoride (PVdF) is melted into N-Methylpyrrolidone (NMP), thereby slurry is produced. Copper foil is coated with the produced slurry, and dried in an oven at about 110° C. for one hour thereby preparing a negative electrode.

Lithium peroxide (Li₂O₂), manganese dioxide (MnO₂) and acetylene black are mixed at a mixing ratio of 40:40:20 by weight, and then, are mixed with a solution in which polyvinylidene fluoride (PVdF) is melted into N-Methylpyrrolidone (NMP), thereby preparing a slurry. Nickel foam having a thickness of 1.6 mm is coated with the prepared slurry, and dried in an oven at 110° C. for three hours thereby preparing a positive electrode.

The electrolyte is made of a solution in which lithium hexafluorophosphate (LiPF₆) is melted in a concentration of 1M into propylene carbonate (PC). GF/C glass filter, for example that manufactured by Whatman Co., is used as a separate filter. The lithium air battery is prepared using a coin cell formed by separately processing 2032 set of Welcos Co. so as to form an air inlet hole at an upper portion thereof.

### Example 2

The lithium air battery is prepared in the same manner as example 1 except that a negative electrode is prepared by mixing silicon powder, graphite and acetylene black at a mixing ratio of 70:25:5 by weight.

### Example 3

The lithium air battery is prepared in the same manner as example 1 except that a negative electrode is prepared by mixing silicon powder, graphite and acetylene black at a mixing ratio of 80:15:5 by weight.

### Example 4

The lithium air battery is prepared in the same manner as example 1 except that a positive electrode is prepared by mixing lithium oxide (LiO₂), manganese dioxide (MnO₂) and acetylene black at a mixing ratio of 40:40:20 by weight.

### Example 5

The lithium air battery is prepared in the same manner as example 1 except that a positive electrode is prepared by mixing lithium peroxide (Li₂O₂), manganese dioxide (MnO₂) and acetylene black at a mixing ratio of 33:33:33 by weight.

### Example 6

The lithium air battery is prepared in the same manner as example 1 except that a positive electrode is prepared by mixing lithium peroxide (Li₂O₂), manganese dioxide (MnO₂) and acetylene black at a mixing ratio of 45:45:20 by weight.

### Example 7

The lithium air battery is prepared in the same manner as example 1 except that a positive electrode is prepared by mixing lithium peroxide (Li₂O₂), manganese dioxide (MnO₂) and acetylene black at a mixing ratio of 50:40:10 by weight.

### Example 8

The lithium air battery is prepared in the same manner as example 1 except that a positive electrode is prepared by mixing lithium peroxide (Li₂O₂), manganese dioxide (MnO₂) and acetylene black at a mixing ratio of 60:30:10 by weight.

### Example 9

The lithium air battery is prepared in the same manner as example 1 except that lithium metal foil is used as a negative electrode.

### Comparative Example 1

Manganese dioxide (MnO₂) and acetylene black are mixed at a mixing ratio of 1:1 by weight, and then, are mixed with a solution in which polyvinylidene fluoride (PVdF) is melted into N-Methylpyrrolidone (NMP), thereby producing a slurry. A nickel form, having a thickness of about 1.6 mm, is coated with the produced slurry, and dried in an oven at about 110° C. for three hours thereby manufacturing a positive electrode.

Electrolyte is made of a solution in which lithium hexafluorophosphate (LiPF₆) is melted in the concentration of about 1M into propylene carbonate (PC).

Lithium metal foil is used as a negative electrode, and GF/C glass filter, e.g., manufactured by Whatman Co., is used as a separate filter. The lithium air battery is prepared using a coin cell formed by separately processing a 2032 set of Welcos Co. so as to form an air inlet hole at an upper portion thereof.

### Test Example 1

The lithium air batteries having been prepared in Examples 1 to 9 were tested for the discharge capacity thereof while charged up to about 4.2 V with constant current-constant voltage and then discharged down to about 2V with a constant voltage, and the lithium air battery which has been prepared in Comparative example 1 was tested for the discharge capacity thereof while being discharged down to about 2V.

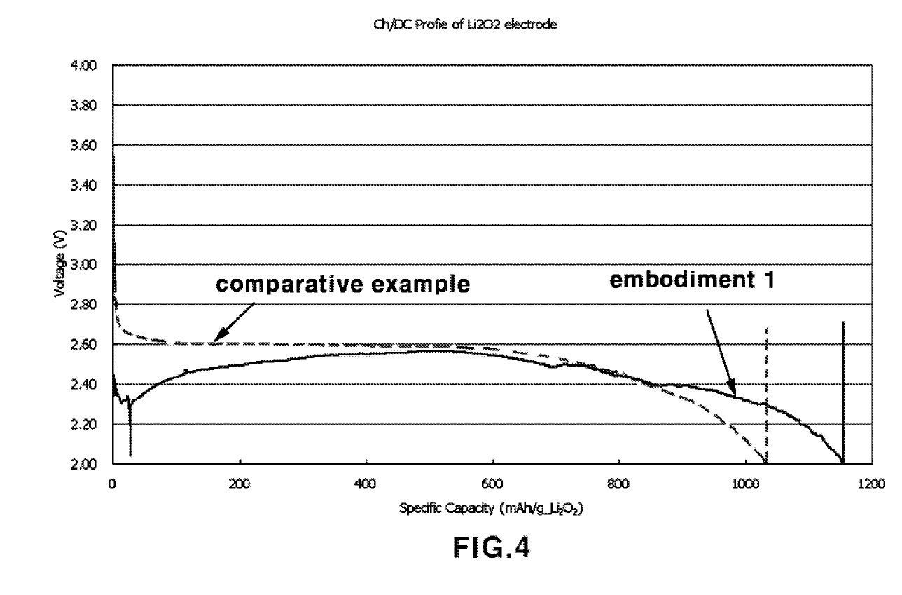

As a result of the electrochemical estimation of coin cell, it can be seen that the lithium air battery prepared in Example 1 is almost equivalent in its discharge capacity to the lithium air battery prepared in Comparative example 1 (see Table 1 and the graph in FIG. 4).

As can be seen from the comparison which tests discharge capacity of the lithium air batteries prepared in Examples 1 to 9 to the lithium air battery prepared in Comparative example 1, the lithium air batteries prepared in Examples 1 to 9, (i.e., the lithium air batteries according to the present invention) are expected realize the same charge/discharge efficiency and expected life span as the lithium air battery prepared in Comparative example 1, that is, a conventional lithium air battery (see Table 1).

In the graph shown in FIG. 4, the dotted line indicates a discharge reaction in the lithium air battery prepared in Comparative example 1, and the solid line indicates a discharge reaction after a charge reaction in the lithium air battery prepared in Example 1.

TABLE 1

| | Charge capacity | Discharge capacity |
|---|---|---|
| | (mAh/g) | (mAh/g) |
| Example 1 | 1667 | 1150 |
| Example 2 | 1694 | 1135 |
| Example 3 | 1729 | 1141 |
| Example 4 | 2300 | 1380 |
| Example 5 | 1584 | 1125 |
| Example 6 | 1617 | 1132 |
| Example 7 | 1738 | 1199 |
| Example 8 | 1654 | 1075 |
| Example 9 | 1612 | 1435 |
| Comparative | — | 1028 |
| Example 1 | | |

In the Comparative Example of a lithium air battery, the initial state is a charged state and thus it begins with discharge. In the present invention, the initial state is a discharged state, and thus discharge is followed by charge. Therefore, for comparison of primary discharge capacity, the charge capacity of charge value in Comparative Example is not meaningful.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A lithium secondary battery having increased capacity, comprising:
a negative electrode; and
a positive electrode containing lithium oxide or lithium peroxide as an active material.

2. The lithium secondary battery of claim 1, wherein the negative electrode comprises as an active material, the active material selected from any one of a group consisting of a silicon based material, a tin based material and lithium metal.

3. The lithium secondary battery of claim 1, wherein the positive electrode is formed of porous material.

4. A lithium battery having increased capacity, comprising:
a negative electrode; and
a positive electrode having an active material, the active material made of lithium oxide.

5. The lithium battery of claim 4, wherein the negative electrode comprises as an active material, the active material selected from any one of a group consisting of a silicon based material, a tin based material and lithium metal.

6. The lithium battery of claim 4, wherein the positive electrode is formed of porous material.

7. A lithium battery having increased capacity, comprising:
a negative electrode; and
a positive electrode having an active material made of lithium peroxide.

8. The lithium battery of claim 7, wherein the negative electrode further comprises as an active material, the active material selected from any one of a group consisting of a silicon based material, a tin based material and lithium metal.

9. The lithium battery of claim 7, wherein the positive electrode is formed of porous material.
